(19) United States
(12) Patent Application Publication
(10) Pub. No.: US 2002/0117646 A1
(43) Pub. Date: Aug. 29, 2002

(54) Valve

(76) Inventors: Thomas Jessberger, Rutesheim (DE); Achim Rehmann, Kieselbronn (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/061,450

(22) Filed: Feb. 4, 2002

Related U.S. Application Data
(63) Continuation of application No. PCT/EP00/06672, filed on Jul. 13, 2000.

(30) Foreign Application Priority Data
Aug. 3, 1999 (DE) 199 36 456.7

(51) Int. Cl. F16K 1/22

(52) U.S. Cl. 251/305

(57) ABSTRACT

A valve (10) which includes a valve flap (13), a flap frame (12) and a unitary housing (11), with the flap (13) rotatably received and arranged in the frame (12) such that when the flap is closed, it allows only minimal leakage which is insignificant to the operation of the valve. The flap frame (12) has a precision region (21) for preventing an abrupt flow changes, and the unitary housing (11) is cast in a mold in which the preassembled valve parts (12, 13) are arranged. Direct casting of the housing (11) around the valve parts (12, 13) enables the production of several housing parts to be avoided, as well as rendering measures to mount and seal the several parts unnecessary. The housing (11) can be connected to adjacent components in a leakproof manner, and connections for engine crankcase ventilation or fuel tank ventilation can be integrated into the housing (11). The valve can be used as a throttle valve for an internal combustion engine.

### CROSS REFERENCE TO RELATED APPLICATIONS

This application is a continuation of international patent application no. PCT/EPOO/06672, filed Jul. 13, 2000, designating the United States of America, the entire disclosure of which in incorporated herein by reference. Priority is claimed based on Federal Republic of Germany patent application no. DE 199 36 456.7, filed Aug. 3, 1999.

### BACKGROUND OF THE INVENTION

The invention relates to a flap valve which is especially useful as a throttle valve for an internal combustion engine.

Published international patent application no. WO 97/04259 discloses a valve that is used as a throttle valve for an internal combustion engine. To prevent the amount of leakage air through the valve from exceeding a predetermined amount, this throttle valve has a precisely toleranced closing area and a downstream precision area adjacent thereto. The elements of the throttle valve are produced by means of an assembly injection molding process. This process ensures the exactitude of the gap width. Since the ratio of the injection weight of the two components should not be greater than 1:3 to 1:5, it is not possible simultaneously to produce a housing. The throttle valve elements are therefore installed in a sectional housing, which is mounted inside the intake manifold.

Production and assembly of several housing parts is time-consuming and costly, however.

SUMMARY OF THE INVENTION

It is an object of the invention to provide an improved flap valve, which is particularly suitable for use as a throttle valve of an internal combustion engine.

Another object of the invention is to provide a flap valve which can be manufactured relatively inexpensively and in a minimal amount of time.

These and other objects are achieved in accordance with the present invention by providing a valve comprising a fixed flap frame, a valve flap pivotably arranged in the flap frame, and a fixed, one-piece housing molded around the flap frame and valve flap; wherein the housing, the flap frame and the flap are each made of molded synthetic resin material; the flap frame comprises a fixed bearing area; the flap comprises a bearing pin integrally molded in one piece thereon and is injection molded into the flap frame with the bearing pin received in the fixed bearing area so that the flap can rotate relative to the frame and housing between open and closed positions.

The valve according to the invention comprises a housing that has a one-piece design and serves as a connecting piece for the incoming and outgoing line.

To regulate the volumetric flow, a flap is used. This flap is built into a flap frame in such a way that the parts create a gap. The gap has a precisely defined gap geometry to ensure low-wear movement of the flap while providing sufficient leak tightness of the unit without the use of additional sealing materials between flap and flap frame. For this purpose, a closing area and a precision area are provided. The closing area is configured in such a way that it allows only minimal leakage, which is not significant for the operation of the unit. The closing area is formed by the flap frame and the flap. The flap frame represents the outer limit, which the flap contacts with one of its surfaces so as to almost provide a seal. To avoid causing an abrupt flow change during operation of the valve, a precision area having a fluidically suitable progression zone is arranged downstream from the closing area. This precision area is also formed by the flap frame, and the flap passes through it during its movement. In the open flap position, the flap frame represents a flow area for the fluid. This flow area is configured in such a way that the gap between flap and flap frame increases with an increasing aperture angle of the flap.

The flap has bearing areas, which may be molded onto the flap in the form of bearing pins or may serve as a seat for a shaft to which the flap is attached. The flap may be attached to the shaft, for example, by screws, rivets or by welding. The flap with its bearing areas is mounted in the flap frame in such a way that a shaft end or bearing end protrudes from the flap frame and can be used to move the flap. The flap frame can enclose the bearing areas of the flap either partially or completely. If the bearing is partially enclosed by the flap frame, the housing is also provided with bearings areas. If the bearings are enclosed completely by the flap frame, the housing includes only the flap frame. A tribologically suitable material must be selected for the flap frame.

The preassembled valve parts are placed into a mold and are then the one-piece housing is molded around them in a single process step without any additional sealing material. The one-piece configuration eliminates additional components that would otherwise be required for fastening. An inexpensive material, e.g., polyamide, may be selected for the large-volume housing, since the functional parts are decoupled from the housing. Due to the small volume of the valve parts (i.e., valve flap and flap frame), a high-quality material may be used for the functional parts.

One advantageous embodiment of the inventive concept involves the use of an injection molding process to produce the housing. In this embodiment, the pre-assembled valve parts form a part of the injection mold for the housing. After the injection molding process, the preassembled valve parts are sealingly enclosed by the housing.

In accordance with a further variant of the invention, the flap and the flap frame are produced by means of an assembly injection molding process. The injection weight of the components has the optimal ratio of between 1:3 and 1:5. For excessively large differences in the injection weight no machines are currently available. Specific process control makes it possible optimally to adjust the bearing play using the difference in shrinkage of the materials between the flap and the flap frame. This also applies to the gap created by the flap and the flap frame.

It is advantageous to connect the flap with a shaft made of a different material. The shaft can be made of a harder material, e.g., metal, which has, for instance, greater torsion resistance. Various combinations regarding material selection and flap attachment to the shaft are feasible. The shaft can, for example, be placed into an injection mold, and the flap can subsequently be molded around it. This eliminates the mechanical attachment of the flap to the shaft. The shaft may also be placed into the mold if an assembly molding technique is used. Another material combination uses a shaft, e.g., made of metal, which is provided with a coating, e.g., made of synthetic resin material (i.e., plastic).

In one specific embodiment of the invention the housing is sealingly connected with the adjacent components. To this end, a seal may be inserted into a recess provided for this purpose and the housing may subsequently be screwed or clamped to the adjacent components.

Another variant embodiment of the invention, a sealed connection of the housing with the adjacent components is achieved by welding the parts together, for example, by vibration welding.

An advantageous embodiment of the invention is to integrate one or more connecting nipples into the housing. These connecting nipples can be used to connect ventilation lines, e.g., for engine crankcase ventilation or fuel tank ventilation.

In one particularly advantageous embodiment of the invention, the housing is configured as an intake manifold or as a portion of an intake manifold for an internal combustion engine. In this embodiment, the preassembled flap valve unit (i.e., the valve flap and flap frame) is placed directly into the mold for the intake manifold, and the intake manifold is molded around the flap valve assembly. This eliminates additional components, work steps, and costs.

It is advantageous to provide a seat or mount for an electric drive within the housing. This seat may accommodate, for instance, a drive for the flap.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 is a sectional view of a valve in closed position;

FIG. 2 is a sectional view of a valve in open position;

FIG. 3 is a sectional view of a detail of a bearing, and

FIG. 4 is a sectional view of a detail of a bearing.

### DETAILED DESCRIPTION OF PREFERRED EMBODIMENTS

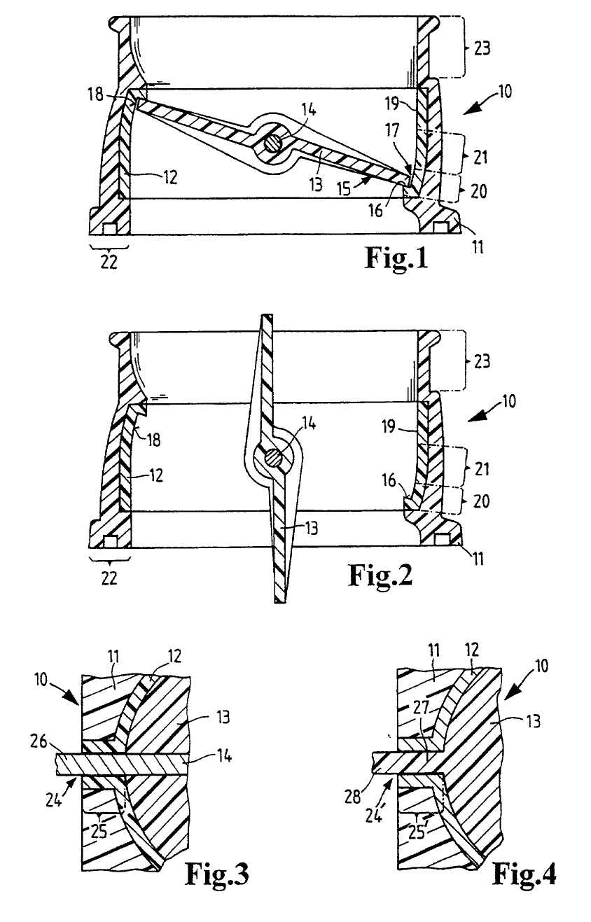

FIG. 1 shows a sectional view of a valve 10 in closed position. Valve 10 has a one-piece housing 11, a flap frame 12, a valve flap 13, and a shaft 14. Flap 13 is fixedly connected with shaft 14, so that a rotary movement of shaft 14 causes a rotary movement of flap 13. In the valve position shown, one end face 15 of flap 13 contacts a support 16.

Flap 13 and flap frame 12 are produced by assembly injection molding. First, shaft 14 is placed into an injection mold, which forms cavities for the flap frame 12, then flap frame 12 is injection molded. After flap frame 12 has sufficiently cooled, the mold is opened and frees the cavities for flap 13. Flap frame 12 forms a part of the mold for flap 13. When flap 13 is subsequently injection molded in this space, the synthetic resin material fills the mold completely and comes into direct contact with flap frame 12. Flap frame 12, however, has sufficiently solidified so that it does not get joined to flap 13. During cooling, flap 13 shrinks and thereby leaves a gap 17. This gap 17 is formed between a circumferential surface 18 of flap 13 and an interior surface 19 of flap frame 12 and can be optimized through process control.

This production method creates neither an offset nor tolerances that result in leaks. Support 16 and end face 15 form a closing area 20, which is adjoined by a precision area 21. The precision area 21 prevents an abrupt flow change.

The preassembled valve unit comprising flap frame 12, flap 13, and shaft 14 is placed into the injection mold for housing 11. Thereafter, the one-part housing 11 is injection molded around the valve unit. After the injection molding process, valve 10 comprises a one-piece housing 11 that encloses flap frame 12. The valve parts 11, 12, 13, 14 do not require any additional seals in relation to one another since they are sufficiently tightly connected with one another.

Housing 11 contains a welding area 22, which can be sealingly welded together with the adjacent component. In addition, housing 11 is configured in such a way that it has a clamping area 23 onto which another adjacent component may be placed and sealingly connected with a pipe clamp.

FIG. 2 depicts valve 10 in its open position. Flap 13 produces the least flow resistance at a 90° aperture angle. By a clockwise rotary movement, the flow resistance increases and the volumetric flow rate decreases. When flap 13 enters the precision area 21 the volumetric flow continuously decreases until flap 13 enters the closing area 20 and valve 10 seals.

FIG. 3 depicts a detail of a bearing 24. In this embodiment shaft 14 is made of metal while flap 13 is made of molded synthetic resin material. Flap 13 is injection molded directly onto shaft 14. The flap frame 12 surrounds the rotatably supported shaft 14 in a bearing 25. Housing 11 does not contact shaft 14, which has a shaft end 26 protruding from valve 10. This shaft end 26 is used to move flap 13.

FIG. 4 shows a detail of another embodiment of bearing 24′. In this embodiment, a bearing pin 27 is formed directly onto flap 13. The bearing pin 27 is rotatably supported in bearing 25′. A protruding bearing pin end 28 is used to move flap 13. In this embodiment, housing 11 is not in direct contact with bearing 25′.

The foregoing description and examples have been set forth merely to illustrate the invention and are not intended to be limiting, since modifications of the described embodiments incorporating the spirit and substance of the invention may occur to persons skilled in the art, the invention should be construed broadly to include all variations falling within the scope of the appended claims and equivalents thereof.

What is claimed is:

1. A valve comprising a fixed flap frame, a valve flap pivotably arranged in said flap frame, and a fixed, one-piece housing molded around the flap frame and valve flap; wherein the housing, the flap frame and the flap are each made of molded synthetic resin material; the flap frame comprises a fixed bearing area; the flap comprises a bearing pin integrally molded in one piece thereon and is injection molded into the flap frame with said bearing pin received in said fixed bearing area so that the flap can rotate relative to the frame and housing between open and closed positions.

2. A valve according to claim 1, wherein the ratio of injection weight of the flap to that of the flap frame is about 1:3.

3. A valve according to claim 1, wherein the housing comprises connecting elements for sealingly connecting the housing to adjacent components.

4. A valve according to claim 3, wherein the housing is sealingly welded together with the adjacent components.

5. A valve according to claim 1, wherein the housing further comprises a connecting sleeve for connecting a vent duct to the housing.

6. A valve according to claim 1, wherein the housing is a component of an internal combustion engine intake manifold.

7. A valve according to claim 1, wherein the housing comprises receptacle or mount for an electric drive for the valve flap.

8. A valve according to claim 1, wherein said valve is a throttle valve for an internal combustion engine.
